(19) United States
(12) Patent Application Publication
(10) Pub. No.: US 2018/0279220 A1
(43) Pub. Date: Sep. 27, 2018

(54) POWER SAVING TRACKING SYSTEM AND POWER SAVING METHOD FOR USING THE SAME

(71) Applicant: FAR EASTONE TELECOMMUNICATIONS CO., LTD., Taipei City (TW)

(72) Inventors: CHE-LUN CHIU, TAIPEI CITY (TW); WEN-HSIEN YU, TAIPEI CITY (TW)

(21) Appl. No.: 15/935,359

(22) Filed: Mar. 26, 2018

(30) Foreign Application Priority Data
Mar. 27, 2017 (TW) 106110206

(51) Int. Cl. H04W 52/02; H04W 4/029; H04L 29/08

(52) U.S. Cl. CPC H04W 52/0209; H04L 67/18; H04W 4/029

(57) ABSTRACT

A power saving tracking system and a power saving method of using the same is disclosed. A tracking device uses at least one positioning module to endlessly record the plurality positional coordinates at a plurality positioning time points. The tracking device upload the positional coordinates and the positioning time points to a cloud server for training at least one power saving mode. The power saving mode includes at least one limited geographical range, at least one limited period, and transmission setting of the wireless transmission module. The cloud server transmits the power saving mode to the tracking device. A processing module of the tracking device determines whether to upload a present positioning time point and a present positional coordinate to the cloud server according to the power saving mode. The present invention reduces the frequency of transmitting information to the cloud server and to decrease power consumption.

This application claims priority for Taiwan patent application no. 106110206 filed on Mar. 27, 2017, the content of which is incorporated by reference in its entirety.

### BACKGROUND OF THE INVENTION

### Field of the Invention

The present invention relates to a tracking device, particularly to a power saving tracking system and a power saving method for using the same.

### Description of the Related Art

With the popularity of wearable devices and portable devices, everyone has at least one smart phone, and their smart watch all have calculation function. Thus, the expansion function of these devices is obvious. Since smart phones and smart watches have satellite positioning function, the smart device can operate in a navigation mode or a safe mode of tracking the position of a user. The smart devices worn by old people or children can prevent old people from getting lost or prevent children from having accidents.

Presently, a tracking device performs two tracking modes. In one tracking mode, the tracking device endlessly receives a satellite signal to transmit positional information to a host. The host may be a mobile device or a computer of a tracker. The tracker can know the position of a tracked object at any time. In another tracking mode, the tracking device continuously transmits the positional information of the satellite signal to a server and sets the movable range of the tracked object. If the tracked object moves out of the movable range, the server will send a message to the tracker, so as to remind the tracker about the whereabouts of the tracked object. In the two modes, the tracking device endlessly transmits the positional information to the electrical device or the server of the tracker. Transmitting data through the Internet consumes more electricity than the satellite positioning technology. As a result, the tracking device consumes electricity very quickly. After the tracking device takes a long time and uses up its electricity, the tracker cannot obtain the position of the tracked object. Accordingly, the meaning that the tracking device guarantees the safety of the user is lost.

To overcome the above mentioned problems, the present invention provides a power saving tracking system and a power saving method for using the same, so as to solve the afore-mentioned problems of the prior art.

### SUMMARY OF THE INVENTION

The primary objective of the present invention is to provide a power saving tracking system and a power saving method for using the same, wherein a cloud server collects positioning information of a tracking device to train a power saving mode suited for a person that wears the tracking device. In the power saving mode, the tracking device does not transmit the positioning information to the cloud server so as to save power consumption caused by transmitting information.

Another objective of the present invention is to provide a power saving tracking system and a power saving method for using the same, which greatly saves power consumption caused by processing data since a processing module of the tracking device does not calculate positioning time and positional coordinates.

Further objective of the present invention is to provide a power saving tracking system and a power saving method for using the same, wherein the power saving mode sets a satellite positioning module and a base-station positioning module of the tracking device. In a power saving mode, one of the satellite positioning module and the base-station positioning module is shut down to save power.

To achieve the above mentioned objectives, the present invention provides a power saving tracking system, which comprises at least one cloud server and at least one tracking device signally connected to the cloud server. The tracking device comprises at least one positioning module, a wireless transmission module, and a processing module. The positioning module is configured to endlessly provide a plurality of positional coordinates respectively corresponding to a plurality of positioning time points. The wireless transmission module is configured to upload the plurality of positional coordinates and the plurality of positioning time points to the cloud server. The processing module is connected to the positioning module and the wireless transmission module and configured to store the plurality of positional coordinates and the plurality of positioning time points and to control the positioning module and the wireless transmission module. The cloud server is configured to collect the plurality of positional coordinates and the plurality of positioning time points provided by the tracking device to train at least one power saving mode. The power saving mode includes at least one limited geographical range, at least one limited period, and transmission setting of the wireless transmission module. The cloud server is configured to transmit the power saving mode to the processing module through the wireless transmission module of the tracking device. The processing module is configured to determine whether to upload a present positioning time point and a present positional coordinate to the cloud server according to the power saving mode.

The positioning module further comprises a satellite positioning module and a base-station positioning module, and the satellite positioning module is configured to provide the plurality of positional coordinates converted from satellite signals that provide the plurality of positioning time points.

The base-station positioning module is configured to use a plurality of base stations upon at least one telephone company to calculate the plurality of positional coordinates.

The wireless transmission module is a 3^{rd} Generation (3G) wireless transmission module, a 4^{th} Generation (4G) wireless transmission module, or a worldwide interoperability for microwave access (WiMAX) wireless transmission module used by communication business.

The power saving mode sets at least one tracking device to start the base-station positioning module and to shut down the satellite positioning module, or shut down the base-station positioning module and the satellite positioning module and control the wireless transmission module to stop uploading the plurality of positional coordinates and the plurality of positioning time points to the cloud server when the limited geographical range is an indoor range within the limited period.

The power saving mode sets the tracking device to control the wireless transmission module and to stop uploading the plurality of positional coordinates. The plurality of positioning time points to the cloud server when the plurality of positional coordinates are located in the limited geographical range within the limited period.

The power saving mode sets the processing module to store the plurality of positional coordinates and the plurality of positioning time points and control the wireless transmission module to stop uploading the plurality of positional coordinates and the plurality of positioning time points to the cloud server.

The tracking device further comprises of a power module connected to the positioning module, a wireless transmission module, and a processing module and also provide power for the positioning module, the wireless transmission module, and the processing module.

The present invention provides a power saving method using a power saving tracking system that comprises of a tracking device and a cloud server, and the power saving method comprises of using at least one positioning device to endlessly record a plurality of positional coordinates respectively corresponding to a plurality of positioning time points of the tracking device by the tracking device; using a wireless transmission module to upload the plurality of positional coordinates and the plurality of positioning time points to the cloud server by the tracking device; collecting the plurality of positional coordinates and the plurality of positioning time points to train at least one power saving mode and transmitting the power saving mode to the tracking module by the cloud server, and the power saving mode includes at least one limited geographical range, at least one limited period, and transmission setting of the wireless transmission module; and determining whether to upload a present positioning time point and a present positional coordinate to the cloud server according to the power saving mode by a processing module of the tracking device.

Below, the embodiments are described in detail in cooperation with the drawings to make it easy to understand the technical contents, characteristics and accomplishments of the present invention.

### BRIEF DESCRIPTION OF THE DRAWINGS

FIG. 1 is a block diagram showing a power saving tracking system according to an embodiment of the present invention;

FIG. 2 is a block diagram showing a power saving tracking system according to another embodiment of the present invention;

FIG. 3 is a flowchart of a power saving method of using a power saving tracking system according to an embodiment of the present invention; and

FIG. 4 is a diagram showing a user wearing a tracking device and located within a limited geographical range according to an embodiment of the present invention.

### DETAILED DESCRIPTION OF THE INVENTION

The present invention provides a power saving tracking system and a power saving method for using the same, which establishes a power saving mode according to the habit of a user, so as to reduce the frequency of transmitting satellite positioning information to a cloud server and decrease power consumption.

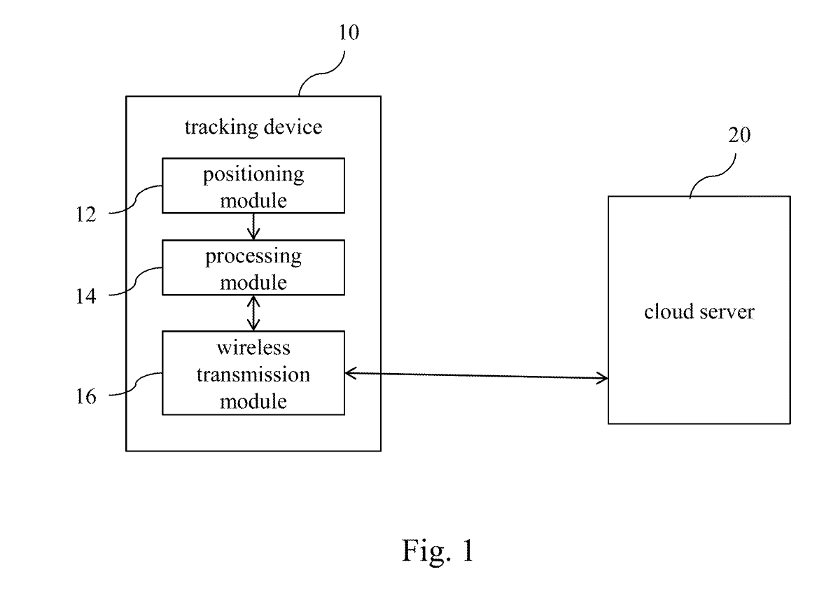

Refer to FIG. 1. FIG. 1 is a block diagram showing a power saving tracking system according to an embodiment of the present invention. In the embodiment, the tracking system of the present invention comprises at least one cloud server 20 and at least one tracking device 10. The tracking device 10 is signally connected to the cloud server 20 through a wireless network. The tracking device 10 comprises at least one positioning module 12, a processing, module 14, and a wireless transmission module 16. The positioning module 12 endlessly provides a plurality of positional coordinates respectively corresponding to a plurality of positioning time points. For example, the first positional coordinate (longitude and latitude) is obtained at the first positioning time point. The second positional coordinate is obtained at the second positioning time point. The frequency of providing the positional coordinates is set by a user, or the manufacturer or the sale business of the tracking device. The wireless transmission module 16 communicates with the cloud server 20 and uploads the positional coordinates and the positioning time points to the cloud server 20. The wireless transmission module 16 is a 3^{rd} Generation (3G) wireless transmission module, a 4^{th} Generation (4G) wireless transmission module, or a worldwide interoperability for microwave access (WiMAX) wireless transmission module used by a communication business, such as a subscriber identity module (SIM). The processing module 14 may be a central processor or a microprocessor, which is connected to the positioning module 12 and the wireless transmission module 16. The processing module 14 stores the plurality of positional coordinates and the plurality of positioning time points corresponded thereof and controls the positioning module 12 and the wireless transmission module 16, such as controlling time that the wireless transmission module 16 transmits the positional coordinates and the positioning time points to the cloud server or control the timing of starting or switching of the positioning module 12. The cloud server 20 collects the plurality of positional coordinates and the plurality of positioning time points provided by the tracking device 10 to train at least one power saving mode. The power saving mode includes at least one limited geographical range, at least one limited period, and transmission setting of the wireless transmission module 16. The cloud server 20 transmits the power saving mode to the processing module 14 of the tracking device 10 through the wireless transmission module 16. The processing module 14 determines whether to upload a present positioning time point and a present positional coordinate to the cloud server 20 according to the power saving mode. In other words, the processing module 14 determines when the wireless transmission module 16 transmits the latest positioning time point and the latest positional coordinate to the cloud server 20 according to the transmission setting of the power saving mode.

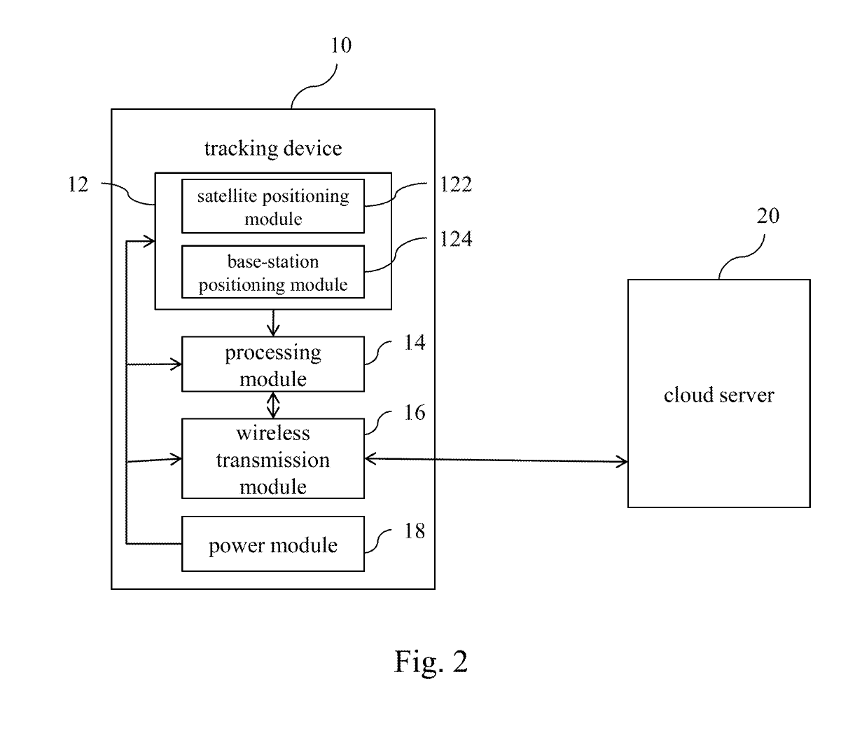

Refer to FIG. 2. FIG. 2 is a block diagram showing a power saving tracking system according to another embodiment of the present invention. In the embodiment, the tracking device 10 further comprises a power module 18 connected to the positioning module 12, the wireless transmission module 16, and the processing module 14 and providing power for the positioning module 12, the wireless transmission module 16, and the processing module 14. Besides, the positioning module 12 further comprises a satellite positioning module 122 and a base-station positioning module 124. The satellite positioning module 122 receives satellite signals that provide the plurality of positioning time points, converts the satellite signals into the positional coordinates, and provides the positional coordinates for the processing module 14. The base-station positioning module 124 uses a plurality of base stations upon at least one telephone company to calculate the plurality of positional coordinates. Since at least three base stations are needed to calculate the coordinates using the triangulation location technology, only the telephone company can support the triangulation location technology. The cloud server 20 starts the satellite positioning module 122 and the base-station positioning module 124, shuts down the satellite positioning module 122 and the base-station positioning module 124, or starts one of the satellite positioning module 122 and the base-station positioning module 124. In the power saving mode, one of the satellite positioning module 122 and the base-station positioning module 124 is shut down or switched, or the satellite positioning module 122 and the base-station positioning module 124 are shut down to save power consumption for positioning.

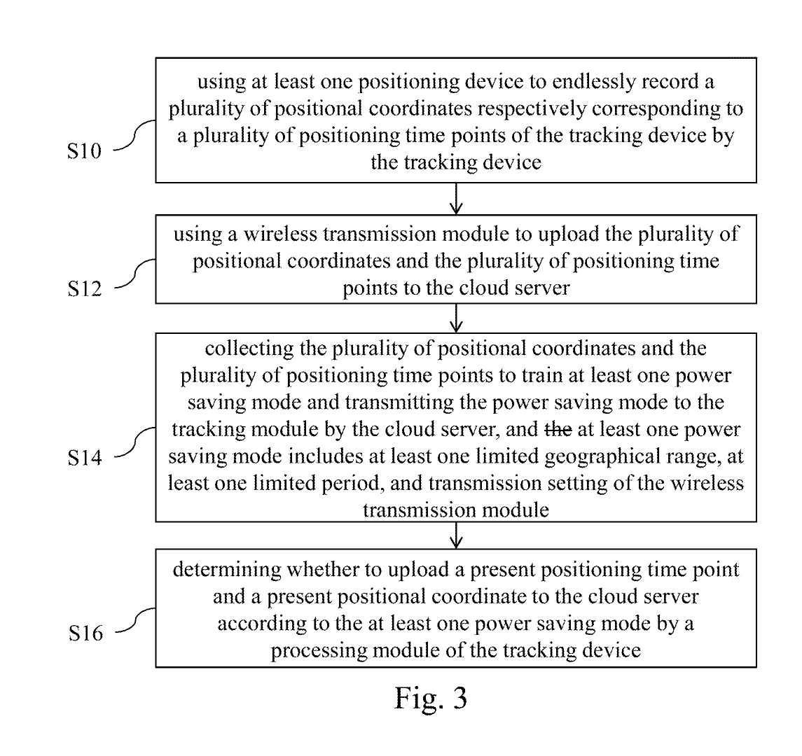

Uploading data consumes the electricity of batteries. In some cases, uploading data consumes more electricity than the satellite positioning technology. The present invention provides a power saving method using the power saving tracking system to transmit little data to the cloud server as much as possible. The flowchart of the power saving method is shown in FIG. 3. Firstly, in Step S10 the tracking device uses at least one positioning device to endlessly record a plurality of positional coordinates that respectively corresponding to a plurality of positioning time points of the tracking device. In step S12, the tracking device uses the wireless transmission module to upload the plurality of positional coordinates and the plurality of positioning time points to the cloud server. Then, in Step S14, the cloud server collects the plurality of positional coordinates and the plurality of positioning time points to train at least one power saving mode and transmits the power saving mode to the tracking module, wherein the power saving mode includes at least one limited geographical range, at least one limited period, and transmission setting of the wireless transmission module. Finally, in Step S16, the processing module of the tracking device determines whether to upload a present positioning time point and a present positional coordinate to the cloud server according to the power saving mode. In this way, when the processing module determines the present positioning time point and the present positional coordinate respectively corresponded in the limited period and the limited geographical range of the power saving mode, the processing module records the present positioning time point and the present positional coordinate rather than uploads the present positioning time point and the present positional coordinate to the cloud server, thereby greatly reducing the frequency of uploading data and saving the power of the tracking device.

Since the cloud server needs to collect the positional information of the user to establish the power saving mode corresponding to the behavior of the user in the beginning, the power cannot be saved when the power saving mode is not established yet during the period that the user begins to wear the tracking device. This period is about two weeks. Afterwards, the cloud server calculates a specific position at a specific time point according to the habit of the user that trained in the power saving mode. If the user works and rests regularly and has been to a few but not many places, the training time of the power saving mode will be reduced.

According to the above mentioned description, the power saving mode includes the setting described as follows. The power saving mode sets the tracking device to start the base-station positioning module and to shut down the satellite positioning module (since the indoor satellite signal is not stable, and the cloud server endlessly receives the unstable signal during the period, the satellite positioning module will shut down), or to shut down the base-station positioning module and the satellite positioning module to control the wireless transmission module to stop uploading the plurality of positional coordinates and the plurality of positioning time points to the cloud server when the limited geographical range is an indoor range within the limited period. Besides, the power saving mode sets the tracking device to control the wireless transmission module to stop uploading the plurality of positional coordinates and the plurality of positioning time points to the cloud server when the plurality of positional coordinates are located in the limited geographical range within the limited period. Especially, when the tracking device operates in the power saving mode, the processing module stores the positioning time points and the positional coordinates instead of transmitting the positioning time points and the positional coordinates to the cloud server through the wireless transmission module.

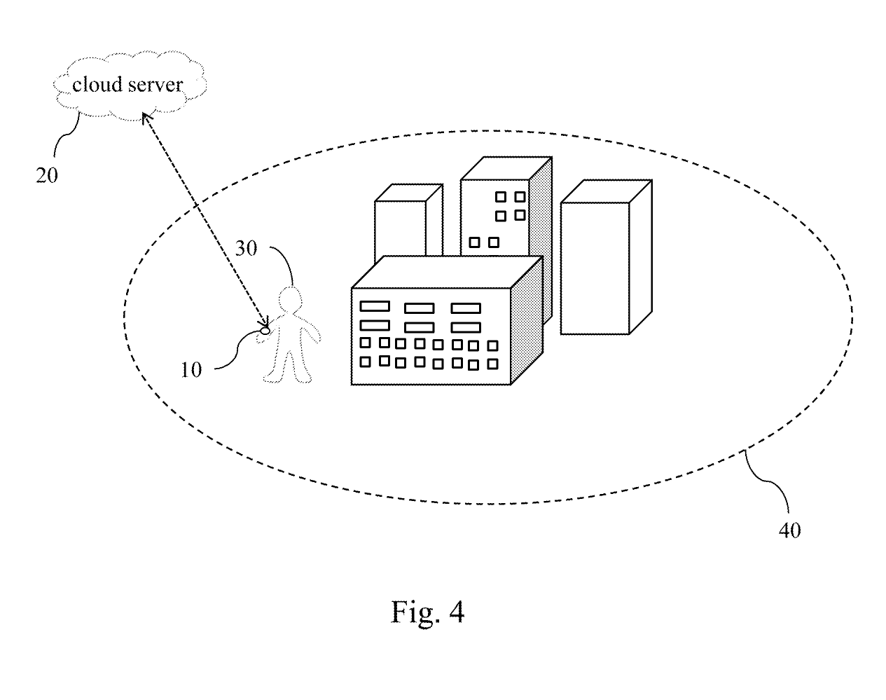

Refer to FIG. 4. FIG. 4 is a diagram showing a user 30 wearing a tracking device 10 and located within a limited geographical range according to an embodiment of the present invention. For example, the user 30 is an old person and located in a house from 19:00 p.m. to 5:00 a.m. the next morning. Thus, the first power saving mode sets the limited period ranging from 19:00 p.m. to 5:00 a.m. the next morning and a limited geographical range 40 being a 100-meter area around the house. Since the indoor satellite signal is bad, the satellite positioning module is shut down, and the base-station positioning module is started. In the limited period, the positioning time points and the positional coordinates are stored in the tracking device 10 rather than uploaded to the cloud server 20. As long as the users 30 leaves the limited geographical range 40 of the house, the processing module of the tracking device 10 uploads the positioning time points and the positional coordinates to the cloud server 20. If this old person exercises or plays chess in a park from 16:00 p.m. to 18:00 p.m., the second power saving mode sets the limited period ranging from 16:00 p.m. to 18:00 p.m. and the limited geographical range 40 being a 100-meter area around the park, starts the satellite positioning module, and shuts down the base-station positioning module. Likewise, in the limited period, the positioning time points and the positional coordinates are stored in the tracking device 10 rather than uploaded to the cloud server 20. As long as the user 30 leaves the limited geographical range 40 of the park, the processing module of the tracking device 10 uploads the positioning time points and the positional coordinates to the cloud server 20.

The present invention is very practical for school children since school children work and rest regularly. Therefore, the first power saving mode operates in a period that school children are located at school. The second power saving mode operates between dinner time and the next morning. If school children cut classes or run away from home in the midnight, the tracking device will report the positioning time points and the positional coordinates back. This way, the parents can track the whereabouts of the school children to ensure their security.

In conclusion, the power saving tracking system and the power saving method for using the same of the present invention transmits the positioning time points and the positional coordinates provided by the tracking device to the cloud server, so as to train the power saving mode suited for the schedule of the user using the tracking device. When the tracking device operates in the power saving mode, the tracking device does not report the positioning information back to the cloud server, in order to save power consumed by transmitting information. In addition, the calculation of training the power saving mode is always performed by the cloud server, and the processing module of the tracking device does not calculate the positioning time points and the positional coordinates, and that greatly saves power that is consumed by processing data. On top of that, the present invention switches the satellite positioning module and the base-station positioning module. For example, in order to save the power for positioning, the satellite positioning module is shut down in indoor space, and the base-station positioning module is shut down in outdoor space. Accordingly, the present invention enhances the endurance of the tracking device.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A power saving tracking system comprising:
at least one cloud server; and
at least one tracking device signally connected to the at least one cloud server, and the at least one tracking device comprises:
at least one positioning module configured to endlessly provide a plurality of positional coordinates respectively corresponding to a plurality of positioning time points;
a wireless transmission module configured to upload the plurality of positional coordinates and the plurality of positioning time points to the cloud server; and
a processing module connected to the at least one positioning module and the wireless transmission module and configured to store the plurality of positional coordinates and the plurality of positioning time points and to control the at least one positioning module and the wireless transmission module,
wherein the at least one cloud server is configured to collect the plurality of positional coordinates and the plurality of positioning time points provided by the at least one tracking device to train at least one power saving mode, the at least one power saving mode includes at least one limited geographical range, in at least one limited period, and transmission setting of the wireless transmission module, the at least one cloud server is configured to transmit the at least one power saving mode to the processing module through the wireless transmission module of the at least one tracking device, and the processing module is configured to determine whether to upload a present positioning time point and a present positional coordinate to the at least one cloud server according to the at least one power saving mode.

2. The power saving tracking system according to claim 1, wherein the at least one positioning module further comprises a satellite positioning module and a base-station positioning module, and the satellite positioning module is configured to provide the plurality of positional coordinates converted from satellite signals that provide the plurality of positioning time points.

3. The power saving tracking system according to claim 2, wherein the base-station positioning module is configured to use a plurality of base stations of at least one telephone company to calculate the plurality of positional coordinates.

4. The power saving tracking system according to claim 1, wherein the wireless transmission module is a 3^{rd} Generation (3G) wireless transmission module, a 4^{th} Generation (4G) wireless transmission module, or a worldwide interoperability for microwave access (WiMAX) wireless transmission module.

5. The power saving tracking system according to claim 2, wherein the at least one power saving mode sets the at least one tracking device to start the base-station positioning module and shut down the satellite positioning module, or shut down the base-station positioning module and the satellite positioning module and control the wireless transmission module to stop uploading the plurality of positional coordinates and the plurality of positioning time points to the at least one cloud server when the at least one limited geographical range is an indoor range within the at least one limited period.

6. The power saving tracking system according to claim 1, wherein the at least one power saving mode sets the at least one tracking device to control the wireless transmission module to stop uploading the plurality of positional coordinates and the plurality of positioning time points to the at least one cloud server when the plurality of positional coordinates are located in the at least one limited geographical range within the at least one limited period.

7. The power saving tracking system according to claim 1, wherein the at least one power saving mode sets the processing module to store the plurality of positional coordinates and the plurality of positioning time points and control the wireless transmission module to stop uploading the plurality of positional coordinates and the plurality of positioning time points to the at least one cloud server.

8. The power saving tracking system according to claim 1, wherein the at least one tracking device further comprises a power module connected to the at least one positioning module, the wireless transmission module, and the processing module and configured to provide power for the at least one positioning module, the wireless transmission module, and the processing module.

9. A power saving method using a power saving tracking system that comprises a tracking device and a cloud server, and the power saving method comprises:
using at least one positioning device to endlessly record a plurality of positional coordinates respectively corresponding to a plurality of positioning time points of the tracking device by the tracking device;
using a wireless transmission module to upload the plurality of positional coordinates and the plurality of positioning time points to the cloud server by the tracking device;
collecting the plurality of positional coordinates and the plurality of positioning time points to train at least one power saving mode and transmitting the at least one power saving mode to the tracking module by the cloud server, and the at least one power saving mode includes at least one limited geographical range, at least one limited period, and transmission setting of the wireless transmission module; and
determining whether to upload a present positioning time point and a present positional coordinate to the cloud server according to the at least one power saving mode by a processing module of the tracking device.

10. The power saving method according to claim 9, wherein the positioning module further comprises a satellite positioning module and a base-station positioning module, and the satellite positioning module is configured to provide the plurality of positional coordinates converted from satellite signals that provide the plurality of positioning time points.

11. The power saving method according to claim 10, wherein the base-station positioning module uses a plurality of base stations of at least one telephone company to calculate the plurality of positional coordinates.

12. The power saving method according to claim 9, wherein the wireless transmission module communicates with the cloud server using a 3^{rd} Generation (3G) protocol, a 4^{th} Generation (4G) protocol, or a worldwide interoperability for microwave access (WiMAX) protocol.

13. The power saving method according to claim 10, wherein the at least one power saving mode sets the tracking device to start the base-station positioning module and shut down the satellite positioning module, or shut down the base-station positioning module and the satellite positioning module and control the wireless transmission module to stop uploading the plurality of positional coordinates and the plurality of positioning time points to the cloud server when the at least one limited geographical range is an indoor range within the at least one limited period.

14. The power saving method according to claim 9, wherein the at least one power saving mode sets the tracking device to control the wireless transmission module to stop uploading the plurality of positional coordinates and the plurality of positioning time points to the cloud server when the plurality of positional coordinates are located in the at least one limited geographical range within the at least one limited period.

15. The power saving method according to claim 9, wherein the at least one power saving mode sets the processing module to store the plurality of positional coordinates and the plurality of positioning time points and control the wireless transmission module to stop uploading the plurality of positional coordinates and the plurality of positioning time points to the cloud server.
